(19) United States
(12) Patent Application Publication
(10) Pub. No.: US 2012/0000336 A1
(43) Pub. Date: Jan. 5, 2012

(54) Steel Alloy

(76) Inventor: Andreas Schremb, (US)

(21) Appl. No.: 13/207,330

(22) Filed: Aug. 10, 2011

Related U.S. Application Data
(63) Continuation of application No. PCT/EP2010/051622, filed on Feb. 10, 2010.

(30) Foreign Application Priority Data
Feb. 10, 2009 (DE) 10 2009 008 285.9

(51) Int. Cl. B23D 35/00; C22C 38/04; C22C 38/02; C22C 38/46; C22C 38/44

(52) U.S. Cl. 83/694; 420/109

(57) ABSTRACT

An alloy, such as a tool steel containing, in percent by weight, 0.5%-0.7% carbon; 1.80%-2.50% chromium; 0.90%-1.20% molybdenum; 3.50%-5.50% nickel and 0.60%-1.50% vanadium. The steel alloyed accordingly is eminently suitable for heat treatments for influencing strength. With a carbon content of less than 0.7%, a partially martensitic metal structure having a high ductility can be formed by way of hardening processes. Due to surface hardening, the carbon content may in some portions on the outer surface be greater than 0.7%.

### CROSS-REFERENCE TO RELATED APPLICATIONS

This application is a continuation of International Patent Application No. PCT/EP2010/051622, filed Feb. 10, 2010, designating the United States, claiming priority under 35 U.S.C. §119(a)-(d) to German Application No. DE 10 2009 008 285.9, filed Feb. 10, 2009, the contents of all of which are hereby incorporated by reference in their entirety as part of the present disclosure.

### FIELD OF THE INVENTION

The invention relates to an alloy for a steel having a nickel content of between 3.5% by wt. and 5.5% by wt.

### BACKGROUND OF THE INVENTION

Such an alloy with 4.5% by wt. is, for example, 45NiCrMoV16-6, according to DIN EN 10 027. According to DIN EN 10 027 Part 2, this alloy is also referred to by the material number 1.2746. Besides nickel, it further contains the following alloy constituents:

### 45NiCrMoV16-6:

Carbon: 0.41-0.49% by wt.
Silicon: 0.15-0.35% by wt.
Manganese: 0.60-0.80% by wt.
Chromium: 1.40-1.60% by wt.
Molybdenum: 0.73-0.85% by wt.
Vanadium: 0.45-0.55% by wt.
Iron: Rest
other inevitable elements and impurities in non-interfering concentrations.

These indications respectively characterize the ratio of the weight of the respective alloy element to the total weight of a sample. The steel alloy is eminently suitable as a tool steel. Besides the indicated constituents, traces of other elements may also be present in the steel. The inevitable impurity elements include, among others, phosphorus and sulfur. They may be brought down to levels of less than 0.1% by wt.

Another generic steel is 28NiMo17, referred to the as material number 1.2747. This comprises the alloy constituents listed below.

### 28NiMo17:

Carbon: 0.24-0.31% by wt.
Silicon: 0.15-0.35% by wt.
Manganese: 0.20-0.80% by wt.
Chromium: 0.30-0.50% by wt.
Molybdenum: 1.15-1.25% by wt.
Nickel: 4.20-4.70% by wt.
Vanadium: 0.15-0.20% by wt.
Iron: Rest
other inevitable elements and impurities in non-interfering concentrations.

28NiMo17 contains the same alloy elements as 45NiCrMoV16-6, but in lower concentrations. Nickel is an exception; this alloy element is present in a higher concentration. Generic alloys are eminently suitable for heat-treatment processes for influencing strength, for instance, hardening, tempering and surface hardening. High-strength, impact-resistant and durable steels for tools may be manufactured therefrom.

A steel alloy is known from JP 09 217 147 A that has the following percentages by weight of constituents: 0.2-0.8 C, no more than 10 Cr, no more than 5 Mo, no more than 3 V, less than 0.1 Si and less than 3 Mn.

A steel alloy is known from JP 56055551 A that has the following constituents in percent by weight: 0.1-0.6 C, less than 8 Cr, one content of Mo, less than 2.5 V, 0.1-1.5 Si and 0.1 to 2 Mn.

The hardening process comprises the process steps of annealing above the so-called austenitizing temperature and subsequent quenching. Water is generally used for quenching. In the tempering process, the workpiece is annealed at low temperatures. In this context, low temperatures are understood to mean temperatures of between 100° C. and 650° C. The austenitizing temperature is the temperature at which the steel material becomes austenitic, that is, at which the atoms in the metal lattice are present in a face-centered cubic manner. In the case of unalloyed steel, the austenitizing temperature is between 723° C. and 1140° C., depending on the carbon content.

During hardening, the steel is heated to a temperature above the austenitizing temperature. During the subsequent cooling-off process, a very hard structure is produced that is referred to as martensite. Apart from this, carbides such as Fe₃C, which are also very hard, are also formed.

A material is ductile if it still exhibits plastic deformation over a wide range instead of breaking after the elastic limit has been exceeded. A measure for ductility is the elongation at break. A greater hardness generally traded off against ductility losses.

By adding alloy elements such as chromium, cobalt, silicon and manganese, the material properties, in particular the temperature behavior, can be influenced. The austenitizing temperature can be reduced by some alloy elements, for example nickel. Great efforts are currently still being made to investigate the influences on steels of individual alloy constituents and, in particular, their combination. The details of what the effects of combinations of metallic and non-metallic alloys are can only be determined empirically or estimated, because the effects of alloy elements on the behavior of the steel are in part contrary.

### SUMMARY OF THE INVENTION

Based on a 45NiCrMoV16-6 steel, the object of the present invention is to provide a steel alloy with high strength and ductility as well as good long-term durability. Furthermore, the steel alloy should be eminently suitable for full hardening with a low embrittlement tendency.

In one aspect, the steel alloy has 3.5-5.5% by wt. nickel, 0.50-0.70% by wt. carbon, 1.70-2.50% by wt. chromium, 0.90-1.50% by wt. molybdenum, 0.60-1.50% by wt. vanadium, and at least 86.00% by wt. iron. In another aspect, apart from silicon and manganese, other elements and impurities may be present only inadvertently in the steel alloy, in non-interfering concentrations. In certain aspects, these are less than 2% by weight and/or each constituent constitutes less than 0.1% by weight. Such constituents can include, but are not limited to, tungsten (W), cobalt (Co), niobium (Nb), zirconium (Zr), copper (Cu), titanium (Ti), tantalum (Ta), boron (B), nitrogen (N), aluminum (Al), sulfur (S), and phosphorus (P).

In some aspects, the alloy may further contain silicon and manganese, including, by way of example only, less than 1.00% by wt. silicon and less than 1.00% by wt. manganese.

In one aspect, the alloy is suitable for tools. By way of example only, a shear blade may be formed comprising steel alloys of the invention.

Other objects and advantages of the present invention will become readily apparent to those of ordinary skill in the art in view of the following detailed description of exemplary embodiments.

### DETAILED DESCRIPTION OF EMBODIMENTS OF THE INVENTION

Alloy 1 is a first embodiment.

### Alloy 1:

Nickel: 3.5-4.5% by wt.
Carbon: 0.50-0.70% by wt.
Chromium: 1.80-2.50% by wt.
Molybdenum: 0.90-1.50% by wt.
Vanadium: 0.60-1.50% by wt.
at least 86.0% by wt. iron and
apart from silicon and manganese, elements and impurities contained only inadvertently in the steel alloy, in non-interfering concentrations.

It should be understood by those skilled in the art that any range specified herein represents any particular amount within that range and any sub-range within the range.

Accordingly, the concentrations of the individual alloy elements may be selected to provide desired beneficial properties of the alloy, e.g., further enhance their positive effects on strength and ductility. For example, the steel alloy may contain 0.52-0.56% by wt. carbon. It may include chromium in the range of 1.70-1.90% by wt. Some embodiments may include a molybdenum content in the range of 1.00-1.20% by wt. Other embodiments may include a vanadium content in the range of 0.70-0.90% by wt. In yet other embodiments, the alloy may include a nickel content of less than 5.00% by wt., or less than 4.50%, or may be in the range of 3.95-4.30% by wt. In some embodiments, the alloy may include a silicon content of less than 1.00% by wt., less than 0.50% by wt. or less than 0.40% by wt., while in other embodiments the silicon content may be in the range of 0.15-0.30% by wt. Alternatively, the silicon content may be more than 0.10% by wt. or more than 0.12% by wt. In some embodiments, the alloy may include a manganese content of less than 1.00% by wt. or less than 0.80% by wt., while in other embodiments the manganese content may be in the range of 0.60-0.80% by wt. Alternatively, the manganese content may be more than 0.50% by wt. In some embodiments, the steel alloy contains at least 89.00% by wt. iron, and in other embodiments may have an iron content in the range of 89.08-90.38% by wt. In certain embodiments, the carbon, chromium, molybdenum, nickel, vanadium, silicon, manganese and iron constitute at least 97% by wt., in some embodiments at least 98% by wt., and in some other embodiments 99% by wt.

The non-interfering elements and impurities may each be present in concentrations of less than 0.10% by wt., or less than 0.05% by wt. However, the phosphorus content according to an embodiment is less than 0.025% by wt.

The addition of nickel can cause the expansion of the so-called austenite area in the iron-carbon diagram. The austenitization area can be shifted towards lower temperatures and towards larger carbon contents. A steel with a high nickel content can be fully hardened well, among other things, because the cooling rate at which martensite forms after annealing above the austenitizing temperature may be lower. Nickel increases the strength with only little ductility loss. Moreover, weldability is not affected by nickel. Nickel improves notch impact strength, in particular at low temperatures.

Chromium increases the strength of the material by approximately 80-100 N/mm² per % by wt. chromium. In the process, the elongation at break is reduced; however, it was found that the elongation at break is only slightly reduced with a chromium content of 1.9 to 2.2% by wt. Chromium is a strong carbide former, which means that the tendency of the material to form carbides, which tend to be very hard, is increased in the case of elevated chromium content. Moreover, chromium improves the capability of being fully hardened.

Vanadium improves high-temperature strength and suppresses susceptibility to overheating. An increase in the vanadium content leads to the possibility of avoiding negative influences, for example, due to embrittlement or scaling, that are the result of heat-treatment and tempering.

Molybdenum increases tensile strength, has a positive effect on weldability and is a strong carbide former. Molybdenum reduces the embrittlement tendency of the steel during tempering. However, molybdenum reduces the size of the austenite area in the iron-carbon diagram.

The alloy is particularly well suited for tool steels, in particular for steels for separating, i.e., for cutting, punching and machining. However, the steel alloy according to the invention is also suitable for tools for forging, pressing, embossing, pressure die-casting and plastic molding. The reason for this is understood to be that, after a hardening process, the steel contains hard structural constituents that are surrounded by a ductile, that is, viscoelastic, structure. Because of this combination, an externally applied load cannot damage the tool by means of contact with the workpiece to be processed.

According to some embodiments, the workpiece, for example the tool, is martensitically hardened only in part. Besides martensite, iron carbides and a pearlitic structure may then be present in the workpiece, so that the structure does not tend to crack if subjected to a compressive load. This structure is produced by a steel that has been annealed above the austenitizing temperature and is cooled off so slowly that only a small content of martensite is produced. Hardening may be to a hardness degree of 30 to 80 HRC Rockwell. In some embodiments, the hardness is 50 to 60 HRC. In still some other embodiments, the hardness is 55 to 56 HRC. Tools for separating should not break, but may deform in the case of loads that are too high, so that they do not lose their functional capability even after being subjected to large loads. It was found that workpieces manufactured from alloy 1 can attain tensile strengths of 700 to 900 N/mm² with a comparatively great hardness of 50 to 60 HRC Rockwell.

Moreover, the wear properties can be improved by nitriding. A hard surface layer of iron nitrides is produced during nitriding.

Another embodiment, alloy 2, specified and described below, contains the same alloy constituents as alloy 1, but with more narrowly limited ranges. It has been found that in alloy 2, ductility, strength and long-term durability are further enhanced.

### Alloy 2:

Carbon: 0.50-0.58% by wt.
Chromium: 1.90-2.20% by wt.
Molybdenum: 1.00-1.20% by wt.
Nickel: 4.00-4.30% by wt.
Vanadium: 0.80-1.00% by wt.
Iron: Rest, and
apart from silicon and manganese, elements and impurities contained only inadvertently in the steel alloy, in non-interfering concentrations.

Particularly good results can be obtained if the steel, alloyed in accordance with alloy 2, is hardened and subsequently tempered. It is noticeable that a wider range is specified for the nickel content as compared with the 45NiCrMoV 16-6 steel. The alloy elements nickel and manganese expand the austenite area, while molybdenum and chromium make it smaller. By increasing the nickel content, the influences of chromium and molybdenum on the austenite area may be compensated for.

The more carbon that is contained in a steel, the greater the amount of martensite that can be formed. Starting from 0.6% carbon, a brittle structure may be produced by a hardening process. In embodiments containing only up to 0.58% carbon, only a partly martensitic structure is produced in the workpiece during hardening. The work piece may thus retain a certain minimum ductility and does not become overly brittle.

In some embodiments, the steel alloy contains less than 0.5% by wt. of silicon and less than 1.0% by wt. manganese. Silicon increases the scaling resistance as well as tensile strength and elongation at break of the steel. Manganese increases the strength of the steel and has a favorable effect on forgeability and weldability. This means that a steel to which manganese has been added may be cold-hardened and deformed well, and that furthermore, the damage to the structure and the tendency to produce internal stress during thermal influences due to welding are kept low. Like nickel, manganese also expands the austenite area.

Some embodiments contain between 0.15 and 0.35% by wt. silicon and between 0.6 and 0.8% by wt. manganese. At these concentrations, the effect of the manganese on reducing the elongation at break, and the influence of silicon that reduces the toughness properties of the material, are hardly measurable, and in cooperation with the other alloy constituents according to the invention, a tool steel with further improved toughness properties can be provided.

High toughness may be advantageous for a tool steel that is exposed to frequent impacts at high loads, which may lead to tensile and compressive stresses of between 200 and 900 N/mm² in the steel. In the case of an impact in which the elasticity limit of the material is exceeded, the steel will deform plastically, but not break. Cold-hardening even occurs in the area of plastic deformation, so that the strength property during use of the tool steel can be improved.

The steel alloys according to the invention may be suitable, for example, for producing blades for scrap shears. Scrap shears need to be harder than the scrap metal they have to cut, which is why they are hardened, e.g., fully hardened.

Alloy 3 is another embodiment.

### Alloy 3:

C % by wt. 0.52-0.56
Si % by wt. 0.15-0.30
Mn % by wt. 0.60-0.80
Cr % by wt. 1.70-1.90
Mo % by wt. 1.00-1.20
Ni % by wt. 3.95-4.30
V % by wt. 0.70-0.90, and
89.08-90.38% by wt. Fe.
Impurities and undesired alloy constituents max. 1% by wt.

The steel alloy may have more than 0.1% by wt. silicon, for example, more than 0.12% by wt. silicon, and/or it has more than 0.4% by wt. manganese, for example, more than 0.5% by wt. manganese. The steel alloy may have at least 86% by wt., in some embodiments 88% by wt., in other embodiments 90% by wt. and yet other embodiments 91% by wt. iron.

The applicant reserves the right to combine any features and sub-features from the claims description and/or the description with one another, even if such a combination is not expressly indicated. If, in a description of an alloy, the words “in particular” and/or “preferably”” or the like are contained, then this is to be understood to mean that each possibility specified with “in particular,” “preferably” or the like may be selected individually. Thus, for example, if the word “in particular” or “preferably” is present the first time in a phrase, the directly following indication may be selected, and this independently from all further indications of “in particular,” “preferably,” or the like, respectively, in the same phrase, respectively. In this respect, each individual sub-feature in a phrase may be selected individually and independently from all other sub-features.

As should be recognized by those of ordinary skill in the pertinent art based on the teachings herein, numerous changes and modifications may be made to the above-described and other embodiments of the present invention without departing from its scope as defined in the appended claims. Accordingly, this detailed description of embodiments is to be taken in an illustrative, as opposed to a limiting, sense.

What is claimed is:

1. A steel alloy consisting essentially of:
3.5-5.5% by wt. nickel;
0.50-0.70% by wt. carbon;
1.70-2.50% by wt. chromium;
0.90-1.50% by wt. molybdenum;
0.60-1.50% by wt. vanadium;
less than 1.0% by wt. silicon;
less than 1.0% by wt. manganese; and
at least 86.00% by wt. iron.

2. The steel alloy according to claim 1, wherein the carbon content is in the range of 0.52-0.56% by wt.

3. The steel alloy according to claim 1, wherein the chromium content is in the range of 1.80-2.50% by wt.

4. The steel alloy according to claim 1, wherein the chromium content is in the range of 1.70-1.90% by wt.

5. The steel alloy according to claim 1, wherein the molybdenum content is in the range of 1.00-1.20% by wt.

6. The steel alloy according to claim 1, wherein the vanadium content is in the range of 0.70-0.90% by wt.

7. The steel alloy according to claim 1, wherein the nickel content is less than 5.00% by wt.

8. The steel alloy according to claim 1, wherein the nickel content is less than 4.50% by wt.

9. The steel alloy according to claim 1, wherein the nickel content is in the range of 3.95-4.30% by wt.

10. The steel alloy according to claim 1, wherein the silicon content is less than 0.40% by wt.

11. The steel alloy according to claim 1, wherein the silicon content is in the range of 0.15-0.30% by wt.

12. The steel alloy according to claim 1, wherein the manganese content is less than 0.80% by wt. manganese.

13. The steel alloy according to claim 1, wherein the manganese content is in the range of 0.60-0.80% by wt.

14. The steel alloy according to claim 1, wherein:
said carbon content is in the range of 0.52-0.56% by wt.;
said chromium content is in the range of 1.70-1.90% by wt.;
said molybdenum content is in the range of 1.00-1.20% by wt.;
said nickel content is in the range of 3.95-4.30% by wt.;
said vanadium content is in the range of 0.70-0.90% by wt.;
said silicon content is in the range of 0.15-0.30% by wt.;
said manganese content is in the range of 0.60-0.80% by wt.; and
said iron content is at least 86.00% by wt.,
and wherein the carbon, chromium, molybdenum, nickel, vanadium, silicon, manganese and iron in the steel alloy constitutes at least 97% by wt. thereof.

15. The steel alloy according to claim 14, wherein carbon, chromium, molybdenum, nickel, vanadium, silicon, manganese and iron in the steel alloy constitutes at least 98% by wt. thereof.

16. The steel alloy according to claim 14, wherein the carbon, chromium, molybdenum, nickel, vanadium, silicon, manganese and iron in the steel alloy constitutes at least 99% by wt. thereof.

17. The steel alloy according to claim 1, wherein
the silicon content is one of (i) less than 0.50% by wt.; and (ii) in the range of 0.15-0.35% by weight; and
the manganese content is one of (i) less than 0.80% by wt. and (ii) in the range of 0.15-0.35% by weight.

18. The steel alloy according to claim 1, wherein the silicon content is more than 0.10% by wt.

19. The steel alloy according to claim 1, wherein the silicon content is more than 0.12% by wt.

20. The steel alloy according to claim 1, wherein the manganese content is more than 0.40% by wt.

21. The steel alloy according to claim 1, wherein the manganese content is more than 0.50% by wt.

22. The steel alloy according to claim 1, wherein the iron content is one of (i) at least 89.00% by wt.; and (ii) in the range of 89.08-90.38% by wt.

23. A steel alloy comprising:
3.5-5.5% by wt. nickel;
0.50-0.70% by wt. carbon;
1.70-2.50% by wt. chromium;
0.90-1.50% by wt. molybdenum;
0.60-1.50% by wt. vanadium;
at least 86.00% by wt. iron; and
less than 2% by weight impurities.

24. The steel alloy according to claim 23, further comprising less than 1.00% by wt. silicon and less than 1.00% by wt. manganese.

25. The steel alloy according to claim 23, wherein said impurities constitute less than 1% by weight.

26. The steel alloy according to claim 23, wherein said impurities include at least one of
tungsten (W);
cobalt (Co);
niobium (Nb);
zirconium (Zr);
copper (Cu);
titanium (Ti);
tantalum (Ta);
boron (B);
nitrogen (N);
aluminum (Al);
sulfur (S); and
phosphorus (P).

27. The steel alloy according to claim 23, wherein each of said impurities constitutes less than 0.1% of the alloy by wt.

28. The steel alloy according to claim 23, wherein each of said impurities constitutes less than 0.05% of the alloy by wt.

29. A shear blade comprising the steel alloy according to claim 1.
